(19) United States
(12) Patent Application Publication
(10) Pub. No.: US 2019/0391046 A1
(43) Pub. Date: Dec. 26, 2019

(54) FIRST LEVEL PACKAGE FOR PRESSURE SENSOR MODULE

(71) Applicant: Sensata Technologies, Inc., Attleboro, MA (US)

(72) Inventors: Frank G.D. Morsink, Aadorp (NL); Andrew C. Herron, Tyrone (GB)

(73) Assignee: Sensata Technologies, Inc., Attleboro, MA (US)

(21) Appl. No.: 16/015,547

(22) Filed: Jun. 22, 2018

(51) Int. Cl. G01M 15/10; G01L 9/04

(52) U.S. Cl. CPC G01M 15/106; G01L 9/04

(57) ABSTRACT

A first level package for a pressure sensor module includes a lead frame which contains a circuit and one or more passive devices. A ceramic substrate is attached to the lead frame via an adhesive bond. The substrate contains conductive traces printed on the substrate. Conductive bonds are used to connect the circuit, the substrate and the lead frame together. After bonding, the pressure sensor module is encapsulated by a thermoset epoxy resin overmold which is then sealed within a pressure sensor housing.

### FIELD

The present disclosure relates to pressure sensors and, more particularly, to a first level package for a pressure sensor module for use in an internal combustion engine.

### BACKGROUND

In the automotive industry, pressure sensors are typically incorporated into fuel systems, braking systems, vehicle stability systems, and the like. For example, exhaust systems of internal combustion engines in passenger cars and commercial vehicles usually require the presence of particulate filters (such as soot filters) to satisfy industry requirements. However, periodic regeneration of the filter is needed when the filter gets clogged. For triggering this regeneration process, a sensor for measuring pressure drop over the filter is often used.

In some applications, pressure drop measurement can be accomplished by a MEMS-based pressure sensing element. A protective gel is often placed around the sensing element to provide mechanical isolation against deposits and offer protection of the sensing element against damage by the environment. For relative pressure sensing, one side of the sensing element typically measures the exhaust pressure before it passes through the filter, and the other side of the sensing element measures the exhaust pressure after it passes through the filter. For absolute sensing, only one side of the sensing element measures the exhaust pressure relative to a pre-defined pressure.

Electronic packaging known as a “first level package,” which provides interconnection of the sensing element directly to the integrated circuit chip, is often used to reduce material cost and the number of assembly steps required to manufacture the pressure sensor. As the use of pressure sensing technology becomes more widespread, there is an increasing need for a first level package which displays robustness to acidic conditions. However, medium exposure testing on standard first level packages has shown vulnerability to corrosion, particularly in an exhaust gas environment.

### SUMMARY

Described herein is a first level package for a pressure sensor module with improved robustness to acidic conditions, such as those found in automotive exhaust environments. The first level package includes a lead frame which contains a circuit and one or more passive devices. A ceramic substrate is attached to the lead frame via an adhesive bond. The substrate contains conductive traces printed on the substrate. Conductive bonds are used to connect the circuit, the substrate and the lead frame together. After bonding, the pressure sensor module is encapsulated by a thermoset epoxy resin overmold which is then sealed within a pressure sensor housing. Advantageously, the first level package of this disclosure provides an increased robustness of the pressure sensor module, as well as a smaller and simplified package, which can lead to lower manufacturing costs.

Further examples of the first level package of this disclosure may include one or more of the following, in any suitable combination.

In examples, the first level package system of this disclosure includes a lead frame having electrical components and a substrate coupled to the frame. A sensing element is mounted to the substrate and in electrical communication with the lead frame. The sensing element is configured to generate a signal in response to a pressure exerted on the sensing element. An ovenmold encapsulating at least a portion the lead frame and the substrate forms a first cavity around the sensing element on the substrate.

In further examples, the electrical components include an application-specific integrated circuit (ASIC). In examples, the substrate further includes a plurality of conductive elements partially covered by the overmold. In examples, the overmold is fabricated from a thermoset epoxy resin material. In examples, the system is configured for use in an internal combustion engine of a vehicle. In examples, the system further includes a plurality of conductive bonds connecting the electrical components and the lead frame. In examples, the substrate defines a central opening extending between a first side of the substrate and a second side of the substrate opposite the first side, and the sensing element covers the central opening to seal the first cavity from the second side of the substrate. In examples, the system further includes an encapsulation material within the first cavity and covering the sensing element. In examples, the lead frame, the electrical components and the substrate are preassembled prior to being encapsulated by the overmold.

In yet further examples, the system includes a housing that forms a first pressure chamber about the first cavity. In examples, the housing includes at least one inlet in fluid communication with the first pressure chamber to allow a pressurized fluid to enter the first pressure chamber. In examples, the sensing element is an absolute pressure sensing element. In examples, the sensing element is a MEMS-based pressure sensing element configured to sense a pressure difference between a first side of the substrate and a second side of the substrate. In examples, the substrate defines a central opening extending from a first side to a second side opposite the first side, with the overmold forming a first cavity around the sensing element and a second cavity about the central opening on the second side. In examples, the system further includes a housing forming a first pressure chamber about the first cavity and a second pressure chamber about the second cavity. In examples, the housing includes at least a first inlet in fluid communication with the first pressure chamber and a second inlet in fluid communication with the second pressure chamber to allow a fluid having a first pressure to enter the first pressure chamber and a fluid having a second pressure to enter the second pressure chamber so that the sensing element generates a signal indicative of differential pressure.

Examples of a method for fabricating a first level package system of this disclosure include fabricating an electronics module assembly including a lead frame. A substrate is then coupled to the frame. The substrate includes a central opening extending between a first side of the substrate and a second side of the substrate opposite the first side. A sensing element is then mounted to the first side of the substrate around the central opening in electrical communication with the electronics module assembly. The electronics module assembly is then encapsulated with a thermoset epoxy resin overmold such that a first cavity is formed around the first side of the substrate.

In further examples, the method includes sealing the system within a housing that forms a first pressure chamber about the first cavity The housing includes at least one inlet in fluid communication with the first pressure chamber for allowing a pressurized fluid to enter the first pressure chamber. In examples, the method includes covering the sensing element with an encapsulation material within the first cavity so that the sensing element completely covers the central opening to seal the first cavity from the second side of the substrate. In examples, the method includes connecting electronics of the electronics module assembly to the lead frame with a plurality of conductive bonds.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The disclosure will be more fully understood by reference to the detailed description, in conjunction with the following figures, wherein:

FIG. 1 is a perspective view of a portion of a pressure sensor module at an intermediate step in the assembly of a first level package according to an example of this disclosure;

FIGS. 2A and 2B are a top perspective view (FIG. 2A) and bottom perspective view (FIG. 2B) of another portion of a pressure sensor module at later intermediate step in the assembly of a first level package according to an example of this disclosure;

FIGS. 3A and 3B are a top perspective view (FIG. 3A) and top plane view (FIG. 3B) of the assembled first level package;

FIG. 3C is a cross-sectional view of the assembled first level package;

FIG. 3D is an exploded view of a pressure sensor module with the first level package together with a pressure sensor housing;

FIG. 4 is a graph of output error of the pressure sensor vs. pressure in the first level package; and

FIGS. 5A and 5B show acid test results on conductive traces on a ceramic substrate mounted on a lead frame according to an example of this disclosure.

### DETAILED DESCRIPTION

In the description that follows, like components have been given the same reference numerals, regardless of whether they are shown in different examples. To illustrate example(s) in a clear and concise manner, the drawings may not necessarily be to scale and certain features may be shown in somewhat schematic form. Features that are described and/or illustrated with respect to one example may be used in the same way or in a similar way in one or more other examples and/or in combination with or instead of the features of the other examples.

As used in the specification and claims, for the purposes of describing and defining the invention, the terms “about” and “substantially” are used to represent the inherent degree of uncertainty that may be attributed to any quantitative comparison, value, measurement, or other representation. The terms “about” and “substantially” are also used herein to represent the degree by which a quantitative representation may vary from a stated reference without resulting in a change in the basic function of the subject matter at issue. “Comprise,” “include,” and/or plural forms of each are open ended and include the listed parts and can include additional parts that are not listed. “And/or” is open-ended and includes one or more of the listed parts and combinations of the listed parts.

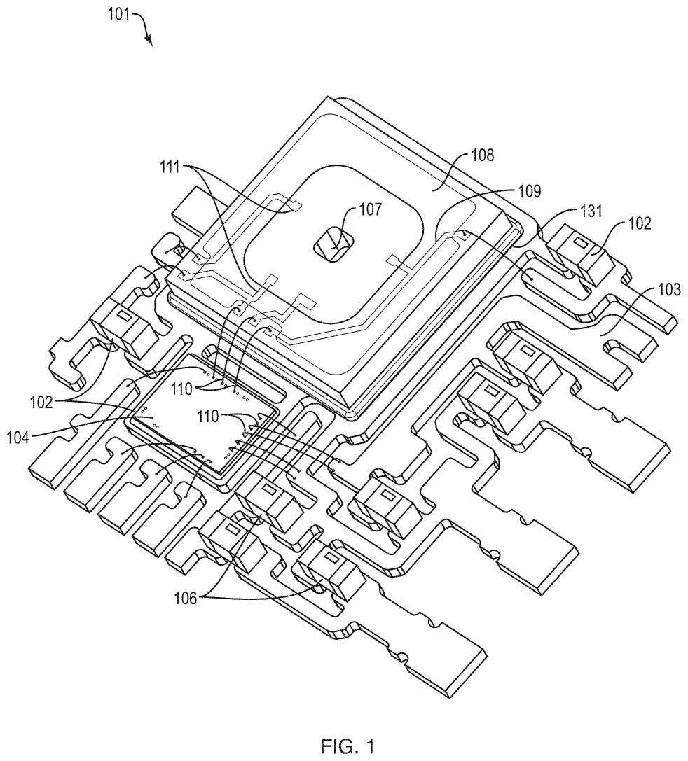

Referring now to FIG. 1, a first portion 101 for a pressure sensing module in accordance with an example of this disclosure is shown. The pressure sensing module can be used as a relative or absolute pressure sensor, for example, in an automotive exhaust system to measure the pressure over a particulate filter. In examples, the pressure is measured by a MEMS-based pressure sensing element, described in more detail below. Alternatively, the sensing element can have a thin-film, foil gauge or bulk silicon gauge design. The pressure sensing module is meant as a sub-assembly to be encapsulated within a sensor overmold before the resulting assembly can be used as a pressure sensor. The pressure sensing module is preferably manufactured completely before encapsulation within the sensor overmold.

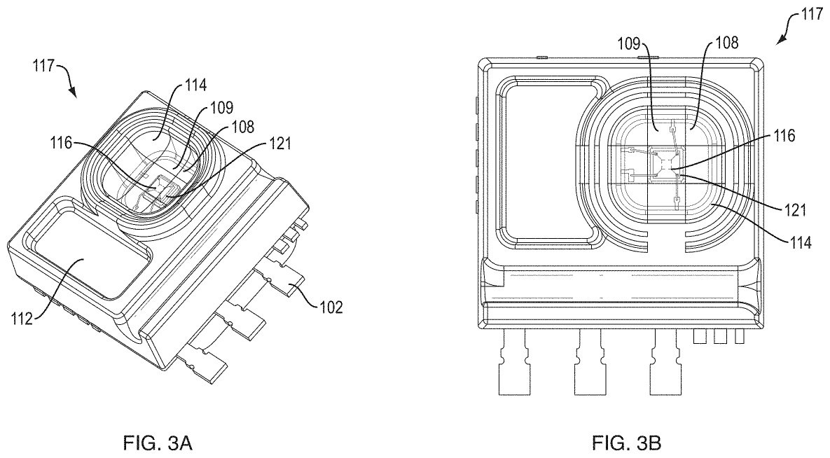

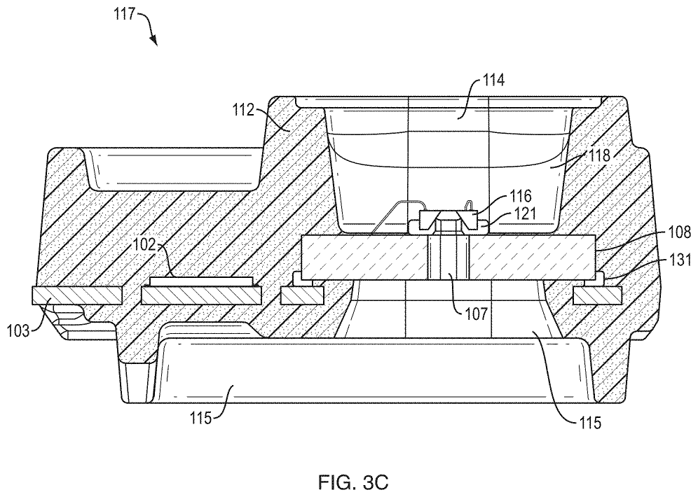

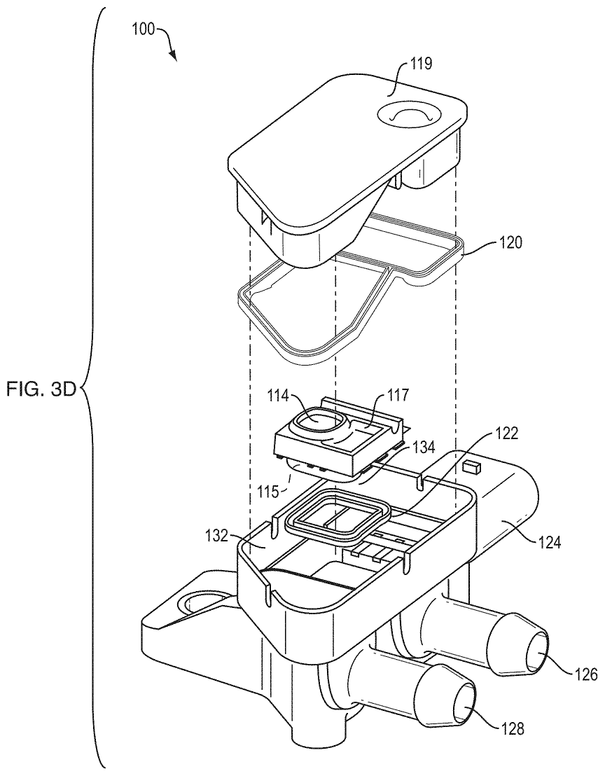

As shown in FIG. 1, a first portion 101 of a first level package 117 (see FIGS. 3A-C) comprises a lead frame 103 coupled to electronic components 102 for conditioning and transmitting a signal. The lead frame 103 and electronic components 102 are generally wired or otherwise connected to form a circuit. The electronic components 102 includes an integrated circuit 104, such as an application-specific integrated circuit (ASIC), and a plurality of passive devices 106, which may include one or more resistors, capacitors, inductors, transformers, and the like. The first portion 101 may further include one or more other electronic components for storing, interpreting, modifying, and/or transmitting signals from various other components. A substrate 108 is attached to the lead frame 103, preferably via an adhesive bond 131. Preferably, the adhesive bond 131 acts as a seal as described below. The substrate 108 is preferably made of a ceramic material, for example, a 96% AL₂O₃ ceramic material. Alternatively, a purer AL₂O₃ ceramic or other suitable ceramic material could be used.

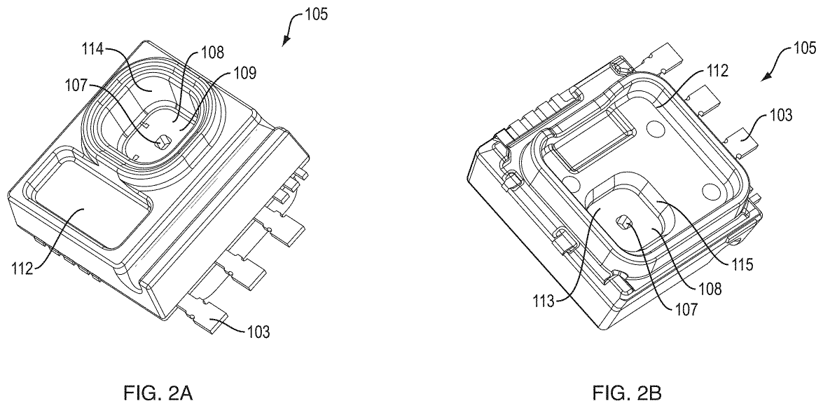

The substrate 108 defines a central opening 107 extending from a first side 109 of the substrate 108 to a second side 113 of the substrate 108 (FIG. 2B). The central opening 107 can be made, for example, by means of laser cutting with a CO₂ laser or by means of a sintering process. The substrate 108 also contains electrically conductive elements 111, or “traces,” printed on the substrate 108. A plurality of conductive bonds 110, such as wire bonds, connect the electrical components 102, the traces 111 and the lead frame 103 together to complete the circuit. Preferably, the traces 111 and the bonds 110 are made of noble metals to improve their characteristics with respect to chemical attack and corrosion due to the acidic environment present at both sides of the substrate 108. In examples, the bonds 110 and/or the traces 111 are comprised of gold. In further examples, the traces 111 are comprised of thick film gold.

Turning now to FIGS. 2A and 2B, after bonding the substrate 108 to the lead frame 103, the first portion 101 is encapsulated within an overmold 112 to create a second portion 105. FIG. 2A illustrates a top perspective view of the second portion 105, and FIG. 2B illustrates a bottom perspective view of the second portion 105. In examples, the overmold 112 comprises a thermoset epoxy resin and is formed in one piece. However, it is also contemplated by this disclosure that the overmold 112 is formed from separate parts which detachably join together to enclose the first portion 101. The overmold 112 defines a first cavity 114 aligned with the first side 109 of the substrate 108 and a second cavity 115 aligned with the second side 113 of the substrate 108. However, it is also contemplated by this disclosure that the overmold 112 defines only the first cavity 114 aligned with the first side 109 of the substrate 108, as described in more detail below.

FIGS. 3A and 3B illustrate the final assembled first level package 117 in a top perspective view (FIG. 3A) and a top plane view (FIG. 3B). As shown in FIGS. 3A and 3B, to complete the first level package 117, a pressure sensing element 116, which may be a MEMS-based pressure sensing element, is placed within the first cavity 114 such that the pressure sensing element 116 covers the central opening 107 at the first side 109 of the substrate 108. The sensing element 116 is attached to the substrate 108 by means of a sealant 121. As such, the sensing element 116, the sealant 121, the substrate 108 and the adhesive bond 108 create a leak-tight seal between the first cavity 114 and the second cavity 115. In examples, the pressing sensing element 116 is a relative pressure sensor such as shown in U.S. application Ser. No. 15/704,797, filed Sep. 14, 2017, which is incorporated herein by reference. The pressure sensing element 116 may also be an absolute pressure sensor such as shown in U.S. Publication No. 2017-0074740, filed on Sep. 16, 2015, which is incorporated herein by reference.

Referring now to FIG. 3C, a cross-sectional view of the assembled first level package 117 is shown. After sealing the sensing element 116 to the substrate 108, the conductive bonds 110 are connected between the sensing element 116 and the traces 111. The first cavity 114 is then filled with an encapsulating material 118 to protect the sensing element 116 from contaminants. The material 118 may be in the form of a colloidal suspension of a liquid in a solid, forming a jelly-like material in a more solid form than a solution. The encapsulating material 118 is preferably selected to accurately transmit pressure to the sensing element 116 while isolating the sensing element 116 from surrounding conditions. In examples, the material 118 is relatively clear but, in some embodiments, the material 118 may be opaque. Preferably, the material 118 does not exert additional pressure on the sensing element 116 and is resistant to exhaust gasses.

Referring now to FIG. 3D, an exploded view of a pressure sensor module 100 with the first level package 117 assembled in a pressure sensor housing 124 is shown. To assemble the pressure sensor module 100, the first level package 117 is placed within an interior 132 of the housing 124 and sealed within the housing 124 using a first seal 122. A cover 119 is then attached to the housing 124 using a second seal 120 to create a first pressure chamber 134 about the first cavity 114. The housing 124 also creates a second pressure chamber (not shown explicitly) about the second cavity 115. The housing 124 includes a first inlet 126 in fluid communication with the first pressure chamber 134 and a second inlet 128 in fluid communication with the second pressure chamber for selectively connecting the first and second pressure chambers to desired environments. For example, the first pressure chamber 134 could be connected to an acidic fluid at a relatively higher pressure, and the second pressure chamber could be connected to an acidic fluid at a relatively lower pressure.

In use, relative pressures acting on both sides of the sensing element 116 result in a change in the form of the structure of the sensing element 116. For example, it is contemplated by this disclosure that the sensing element 116 can include a diaphragm (not shown) which is designed to flex in response to the differential pressure between both sides of the sensing element 116. This causes a resistance change in gauges (e.g., piezoresistive elements) of the sensing element 116, which is amplified and conditioned by the conditioning electronic components 102 mounted on the lead frame 103. The conditioning electronic components 102 form electronic circuitry to sense one or more electrical properties of the sensing element 116 and to condition and convert the one or more electrical properties into an output signal for use in the electronic control unit of the vehicle.

Examples of the first level package 117 described above with regard to FIGS. 3A-D relate to a relative pressure sensor. It should be noted, however, that examples of the first level package 117 could also be used to provide an absolute pressure sensor. In this case, the central opening 107 in the substrate 108 would be omitted and the sensor overmold 112 of the first level package 117 would define only the first cavity 114. A predefined and conditioned pressure (e.g., a vacuum) would be typically be created inside the sensing element 116. Thus, the pressure to be measured would act through the first side 109 of the substrate 108. Such a first level package 117 has the advantage that it can be manufactured and tested before it is encapsulated within the sensor overmold 112. In yet further examples (not shown), multiple first level packages 117, omitting the second cavity 115, could be encapsulated within the overmold 112 to provide a dual pressure sensor. It is also contemplated by this disclosure that the electronic components 102 couple be placed on the ceramic substrate 108 without the lead frame 103, and the substrate 108 could be encapsulated within the overmold 112 with the cavities 114, 115 formed on one or both sides of the substrate 108.

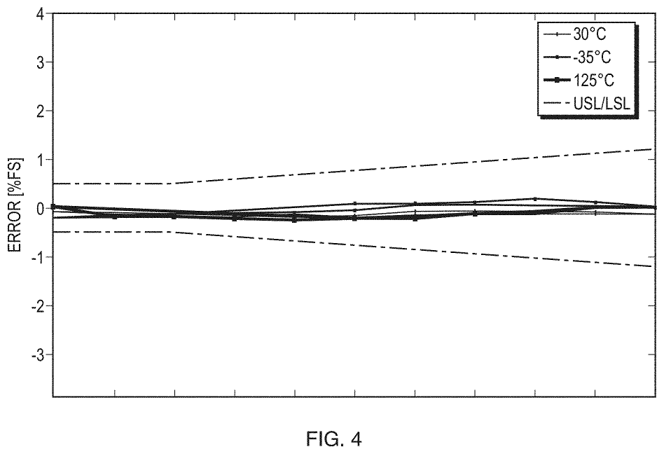

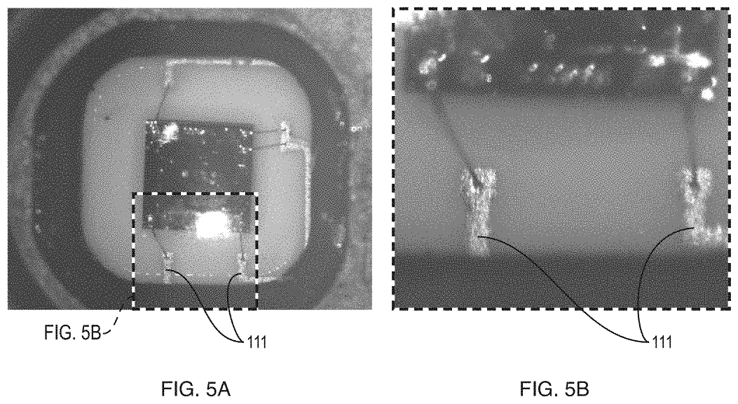

FIG. 4 shows a graph of output error of the pressure sensing element 116 vs. pressure in the first level package 117, demonstrating successful calibration and characterization of the first level package 117. FIGS. 5A and 5B show acid test results on the traces on a ceramic substrate mounted to a lead frame, such as the lead frame 103. The acid test results demonstrate increased resistance to corrosion of the traces 111.

While the disclosure has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting, the full scope rather being conveyed by the appended claims.

What is claimed is:

1. A first level package system for a pressure sensor module, the system comprising:
a lead frame having electrical components;
a substrate coupled to the frame;
a sensing element mounted to the substrate and in electrical communication with the lead frame, the sensing element configured to generate a signal in response to a pressure exerted thereon; and
an overmold encapsulating at least a portion the lead frame and the substrate to form a first cavity around the sensing element on the substrate.

2. The system of claim 1, wherein the electrical components include an application-specific integrated circuit (ASIC).

3. The system of claim 1, wherein the substrate further comprises a plurality of conductive elements partially covered by the overmold.

4. The system of claim 1, wherein the overmold is fabricated from a thermoset epoxy resin material.

5. The system of claim 1, wherein the system is configured for use in an internal combustion engine of a vehicle.

6. The system of claim 1, further comprising a plurality of conductive bonds connecting the electrical components and the lead frame.

7. The system of claim 1, wherein the substrate defines a central opening extending between a first side of the substrate and a second side of the substrate opposite the first side; and wherein the sensing element covers the central opening to seal the first cavity from the second side of the substrate.

8. The system of claim 1, further comprising an encapsulation material within the first cavity and covering the sensing element.

9. The system of claim 1, wherein the lead frame, the electrical components and the substrate are preassembled prior to being encapsulated by the overmold.

10. The system of claim 1, further comprising a housing that forms a first pressure chamber about the first cavity.

11. The system of claim 10, wherein the housing comprises at least one inlet in fluid communication with the first pressure chamber to allow a pressurized fluid to enter the first pressure chamber.

12. The system of claim 1, wherein the sensing element is an absolute pressure sensing element.

13. The system of claim 1, wherein the sensing element is a MEMS-based pressure sensing element configured to sense a pressure difference between a first side of the substrate and a second side of the substrate.

14. The system of claim 1, wherein:
the substrate defines a central opening extending from a first side to a second side opposite the first side;
the overmold forms a first cavity around the sensing element, which covers the central opening; and
the overmold forms a second cavity about the central opening on the second side.

15. The system of claim 14, further comprising a housing forming a first pressure chamber about the first cavity and a second pressure chamber about the second cavity.

16. The system of claim 15, wherein the housing comprises at least a first inlet in fluid communication with the first pressure chamber and a second inlet in fluid communication with the second pressure chamber to allow a fluid having a first pressure to enter the first pressure chamber and a fluid having a second pressure to enter the second pressure chamber so that the sensing element generates a signal indicative of differential pressure.

17. A method for fabricating a first level package system for a pressure sensor module, the method comprising the steps of:
fabricating an electronics module assembly including a lead frame;
coupling a substrate to the frame, the substrate including a central opening extending between a first side of the substrate and a second side of the substrate opposite the first side;
mounting a sensing element to the first side of the substrate around the central opening in electrical communication with the electronics module assembly; and
encapsulating the electronics module assembly with a thermoset epoxy resin overmold such that a first cavity is formed around the first side of the substrate.

18. The method of claim 17, further comprising the step of sealing the system within a housing that forms a first pressure chamber about the first cavity, wherein the housing comprises at least one inlet in fluid communication with the first pressure chamber for allowing a pressurized fluid to enter the first pressure chamber.

19. The method of claim 17, further comprising the step of covering the sensing element with an encapsulation material within the first cavity so that the sensing element completely covers the central opening to seal the first cavity from the second side of the substrate.

20. The method of claim 17, further comprising the step of connecting electronics of the electronics module assembly to the lead frame with a plurality of conductive bonds.
